(19) United States
(12) Patent Application Publication
(10) Pub. No.: US 2011/0263284 A1
(43) Pub. Date: Oct. 27, 2011

(54) RADIO BASE STATION, RADIO RESOURCE ALLOCATION METHOD AND RADIO COMMUNICATION SYSTEM

(75) Inventors: Yasushi Ogawa, Yokohama-shi (JP); Masahide Katayama, Yokohama-shi (JP)

(73) Assignee: KYOCERA CORPORATION, KYOTO (JP)

(21) Appl. No.: 13/141,578

(22) PCT Filed: Dec. 24, 2009
(86) PCT No.: PCT/JP2009/007212

§ 371 Date: Jun. 22, 2011

(30) Foreign Application Priority Data
Dec. 25, 2008 (JP) 2008-330772
Apr. 9, 2009 (JP) 2009-095190

(51) Int. Cl. H04B 7/24

(52) U.S. Cl. 455/509

(57) ABSTRACT

A radio base station for performing radio communication with a plurality of radio terminals by allocating a different radio resource to each of the plurality of radio terminals includes a measurement unit for measuring, at every predetermined timing, a path loss on the radio resource allocated to each of the plurality of radio terminals, a difference information obtaining unit for obtaining difference information Ph between maximum transmit power and current transmit power, transmitted from each of the plurality of radio terminals, and a control unit for controlling allocation of the radio resources to the plurality of radio terminals based on the path loss measured by the measurement unit and the difference information Ph obtained by the difference information obtaining unit. Thereby, the transmit power of the plurality of radio terminals is appropriately controlled and a radio link is maintained stably.

### CROSS REFERENCE TO RELATED APPLICATIONS

This application claims priority to and the benefit of Japanese Patent Application No. 2008-330772 filed on Dec. 25, 2008, and Japanese Patent Application No. 2009-95190 filed on Apr. 9, 2009 claiming priority based thereon, the entire contents of which are incorporated herein by reference.

### TECHNICAL FIELD

The present invention relates to radio base stations, radio resource allocation methods and radio communication systems.

### BACKGROUND ART

There is a conventional radio communication system in which a radio terminal transmits scheduling information including a size of data in a transmission queue and difference information Ph (Power Headroom) between transmittable maximum transmit power and current transmit power to a base station, and the base station determines transmit power of the radio terminal and performs scheduling to control a transmission data rate.

Recently, in addition, standardization of LTE (Long Term Evolution) has been promoted by 3GPP (3rd Generation Partnership Project), for example. In LTE, a transmission bandwidth (resource block) having a plurality of subcarriers is allocated as a radio resource for an uplink (for example, see Non-Patent Document 1). Accordingly, it is assumed that, in LTE, in the same manner as the conventional radio communication system, the radio base station determines the transmit power of the radio terminal based on the scheduling information including the difference information Ph transmitted from the radio terminal and performs scheduling to control the transmission data rate.

### PRIOR ART DOCUMENT

### Non-Patent Document

Non-Patent Document 1: 3GPP TR25.814

### SUMMARY OF INVENTION

### Technical Problem

Incidentally, in the radio communication system which performs communication by allocating the radio resource of different frequency to each of a plurality of radio terminals, there may be a radio resource in a good radio state and a radio resource in a deteriorated radio state, due to changes of the radio state of each radio resource from moment to moment under the influence of frequency selective fading and the like. In this case, as stated above, for a radio terminal using the radio resource in the deteriorated radio state, the base station determines the transmit power based on the difference information Ph from the radio terminal and performs scheduling to control the transmission data rate. Thereby, it is possible to ensure a desired communication quality.

However, in a case where a radio terminal has no room to increase its transmit power, if the radio state of the radio resource allocated to the radio terminal becomes even worse, the radio terminal has difficulty in maintaining the radio link to the radio base station since it is no longer possible to control to increase the transmission power. In contrast, a radio terminal using the radio resource in the good radio state often has room to increase the transmit power.

As stated above, in the radio communication system which performs communication by allocating the radio resource of a different frequency to each of the plurality of radio terminal, it is concerned that, even the radio base station controls the transmit power based on the difference information Ph from the radio terminal, it may be difficult for the radio terminal to maintain the radio link to the radio base station, due to no room to increase the transmit power.

Accordingly, it is an object of the present invention, in consideration of the above problem, to provide radio base stations, radio resource allocation methods and radio communication systems capable of suitably controlling transmit power of a plurality of radio terminals and maintaining stable radio links.

### Solution to Problem

In order to achieve the above object, according to a first aspect of the present invention, there is provided a base station for performing radio communication with a plurality of radio terminals by allocating a different radio resource to each of the plurality of radio terminals, including:

a measurement unit for measuring a path loss on the radio resource allocated to each of the plurality of radio terminals at every predetermined timing;

a difference information obtaining unit for obtaining difference information between maximum transmit power and current transmit power, transmitted from each of the plurality of radio terminals; and

a control unit for controlling allocation of the radio resources to the plurality of radio terminals based on the path loss measured by the measurement unit and the difference information obtained by the difference information obtaining unit.

According to a second aspect of the present invention, in the radio base station according to the first aspect,

the control unit allocates the radio resource with relatively small path loss measured by the measurement unit to the radio terminal with relatively small difference information obtained by the difference information obtaining unit, while allocating the radio resource with relatively large path loss measured by the measurement unit to the radio terminal with relatively large difference information obtained by the difference information obtaining unit.

According to a third aspect of the present invention, the radio base station according to the first or the second aspect further includes:

a communication type information obtaining unit for obtaining communication type information indicating a communication type of each of the plurality of radio terminals, wherein

the control unit controls allocation of the radio resources to the plurality of radio terminals, based on the path loss measured by the measurement unit, the difference information obtained by the difference information obtaining unit and the communication type information obtained by the communication type information obtaining unit.

Moreover, in order to achieve the above object, according to a fourth aspect of the present invention, there is provided a radio resource allocation method of a radio base station for performing radio communication with a plurality of radio terminals by allocating a different radio resource to each of the plurality of radio terminals, including the steps of:

measuring a path loss on the radio resource allocated to each of the plurality of radio terminals at every predetermined timing;

obtaining difference information between maximum transmit power and current transmit power, transmitted from each of the plurality of radio terminals; and

controlling allocation of the radio resources to the plurality of radio terminals based on the path loss measured and the difference information obtained.

Furthermore, in order to achieve the above object, according to a fifth aspect of the present invention, there is provided a radio communication system including a radio base station for performing radio communication with a plurality of radio terminals by allocating a different radio resource to each of the plurality of radio terminals, wherein

each of the plurality of radio terminals includes:

a calculation unit for outputting difference information by calculating a difference between current transmit power and maximum transmit power that the radio terminal can transmit; and

a transmission unit for transmitting the difference information output from the calculation unit to the radio base station, and

the radio base station includes:

a measurement unit for measuring a path loss on the radio resource allocated to each of the plurality of radio terminals at every predetermined timing;

an obtaining unit for obtaining the difference information transmitted from each of the plurality of radio terminals; and

a control unit for controlling allocation of the radio resources to the plurality of radio terminals based on the path loss measured by the measurement unit and the difference information obtained by the obtaining unit.

### Effect of the Invention

According to the present invention, the radio base station obtains the difference information between the maximum transmit power and the current transmit power from each of the radio terminals, measures path states of the plurality of radio resources at every predetermined timing and, based on the path states measured and the difference information obtained, controls allocation of the radio resources to a plurality of radio terminals. Accordingly, it is possible to suitably control the transmit power of the plurality of radio terminals and to maintain a stable radio link between each of the radio terminals and the radio base station.

### BRIEF DESCRIPTION OF DRAWINGS

FIG. 1 is a diagram illustrating a schematic configuration of a radio communication system having a radio base station according to a first embodiment of the present invention;

FIG. 2 is a flowchart illustrating a scheduling operation to allocate radio resource blocks by the radio base station shown in FIG. 1;

FIG. 3 is a pattern diagram illustrating the radio resource block allocation by the radio base station shown in FIG. 1;

FIG. 4 is a diagram illustrating a schematic configuration of a radio communication system having a radio base station according to a second embodiment of the present invention;

FIG. 5 is a flowchart illustrating a scheduling operation to allocate the radio resource blocks by the radio base station shown in FIG. 4; and

FIG. 6 is a flowchart illustrating a scheduling operation to allocate the radio resource blocks by a radio base station according to a third embodiment of the present invention.

### DESCRIPTION OF EMBODIMENTS

Embodiments of the present invention will be described with reference to the accompanying drawings.

### First Embodiment

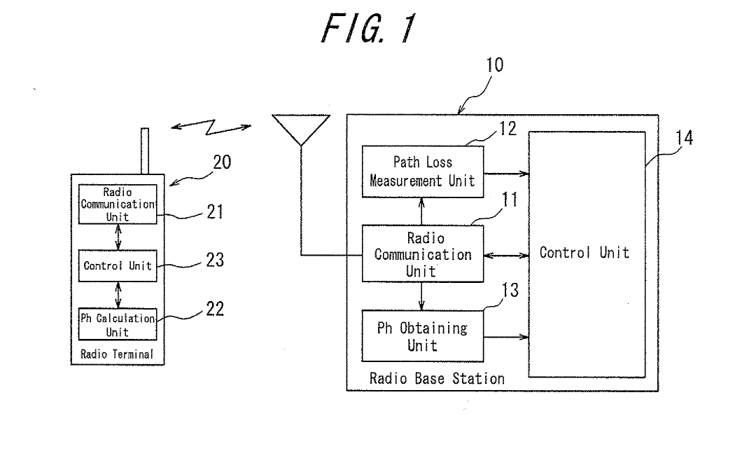

FIG. 1 is a schematic diagram of a radio communication system having a radio base station according to a first embodiment of the present invention. This radio communication system is in conformity with LTE, for example, and a radio base station 10 according to the present embodiment performs radio communications with a plurality of radio terminals 20 by allocating a different radio resource block to each of the radio terminals (note that only one of them is shown in FIG. 1).

The radio base station 10 has a radio communication unit 11, a path loss measurement unit 12, a Ph obtaining unit 13 and a control unit 14. The radio communication unit 11 performs the radio communication with the plurality of radio terminals 20. The path loss measurement unit 12 measures the path loss on radio resource blocks allocated to the plurality of radio terminals 20 based on a signal received from the radio communication unit 11 at every predetermined timing, and provides a result of measurement to the control unit 14.

Here, the predetermined timing to measure the path loss is a processing unit time specified by the system, such as a subframe (1 ms) of a radio frame, for example. In addition, the path loss is measured based on the received electric field intensity of each radio resource block, a packet loss and the like.

The Ph obtaining unit 13 constitutes a difference information obtaining unit and, based on the signal received from the radio communication unit 11, obtains difference information Ph (Power Headroom) between the maximum transmit power and the current transmit power, transmitted from each of the radio terminals 20. Then, the Ph obtaining unit 13 provides the control unit 14 with the difference information Ph obtained. The control unit 14 controls overall operation of the radio base station. In addition, the control unit 14 controls (schedules) allocation of radio resource blocks to the plurality of radio terminals 20 at every predetermined timing based on the path loss measured by the path loss measurement unit 12 and the difference information Ph obtained by the Ph obtaining unit 13. Moreover, the control unit 14 transmits a result of scheduling to a corresponding radio terminal 20 via the radio communication unit 11.

In the radio base station 10, a single CPU (Central Processing Unit) may be employed to implement the path loss measurement unit 12, the Ph obtaining unit 13 and the control unit 14. It is also possible to share processing of the path loss measurement unit 12, the Ph obtaining unit 13 and the control unit 14 by a plurality of CPUs.

Each of the radio terminals 20 includes a radio communication unit 21, a Ph calculation unit 22 and a control unit 23. The radio communication unit 21 includes a transmission unit and a reception unit and performs communication with the radio base station 10 by using the radio resource block allocated thereto. The Ph calculation unit 22 calculates a difference between the maximum transmit power that the radio terminal 20 can transmit and the current transmit power, and provides the control unit 23 with the difference information Ph. The control unit 23 controls overall operation of the radio terminal. The control unit 23 transmits (informs) the difference information Ph obtained from the Ph calculation unit 22 to the radio base station 10 via the radio communication unit 21 periodically or at timing required by the radio base station 10.

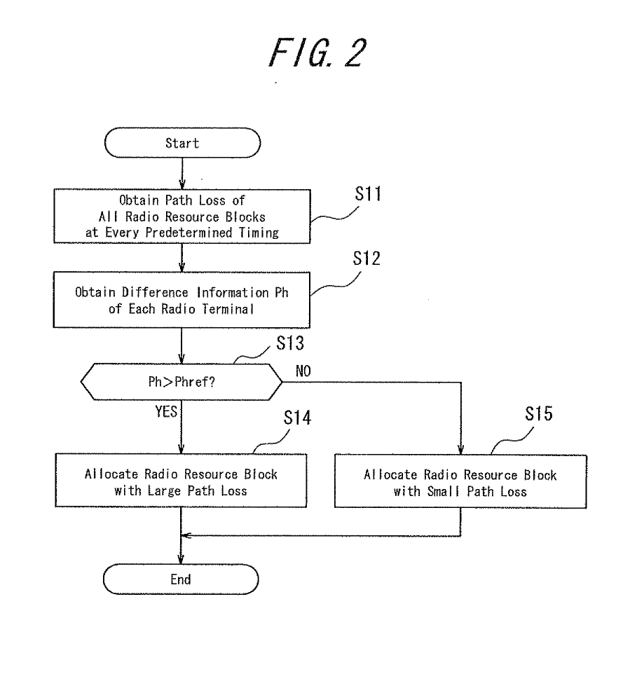

FIG. 2 is a flowchart illustrating a scheduling operation to allocate the radio resource blocks by the radio base station 10 according to the present embodiment. The control unit 14 obtains the path loss of all of the radio resource blocks from the path loss measurement unit 12 at every predetermined timing (step S11). Also, the control unit 14 obtains the difference information Ph of each of the radio terminals 20 from the Ph obtaining unit 13 (step S12) and compares the difference information Ph obtained and a predetermined threshold Phref (step S13).

If Ph>Phref as a result, since the radio terminal 20 has room to increase the transmit power, the control unit 14 schedules allocation of the radio resource blocks such that a radio resource block with a large path loss is preferentially allocated to the radio terminal 20 (step S14). Then, the control unit 14 transmits a result of scheduling to the corresponding radio terminal 20. In contrast, if Ph≦Phref, since the radio terminal 20 has no room to increase the transmit power, the control unit 14 schedules allocation of the radio resource blocks such that a radio resource block with a small path loss is preferentially allocated to the radio terminal 20 (step S15). Then, the control unit 14 transmits a result of scheduling to the corresponding radio terminal 20.

As stated above, the control unit 14 schedules the radio resource blocks allocated to the radio terminals 20 at every predetermined timing based on the radio state of each radio resource block, which changes from moment to moment, and the difference information Ph of each of the radio terminals.

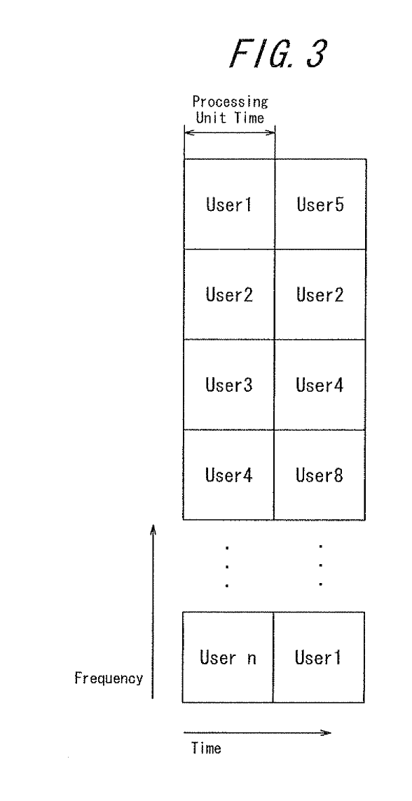

FIG. 3 is a pattern diagram illustrating allocation of the radio resource blocks by the radio base station 10 according to the present embodiment. In FIG. 3, a horizontal axis and a vertical axis represent time and frequency, respectively. In addition, the processing unit time corresponds to a predetermined timing to schedule allocation of the radio resource blocks. As can be seen in FIG. 3, allocation of the radio resource blocks to a plurality of radio terminals shown by User-1 to User-n is changed at the sequential processing unit time (predetermined timing) based on the radio state of each radio resource block and the difference information Ph of each radio terminal. Although a single radio resource block is allocated to each of the users (radio terminals) in FIG. 3, it is also possible, if there are only a small number of connected terminals, to schedule such that a plurality of radio resource blocks is allocated to a single radio terminal.

According to the radio communication system having the radio base station 10 of the present embodiment, a radio resource block with a small path loss, that is, being in a good radio state is preferentially allocated to the radio 20 having the difference information Ph equal to or under the threshold Phref, that is, having no room to increase transmit power. Hence, it is possible to reliably maintain the radio link of the radio terminal 20. In addition, a radio resource block with a large path loss, that is, being in a deteriorated radio state is preferentially allocated to the radio terminal 20 having the difference information Ph exceeding the threshold Phref. Since the radio terminal 20 has room to increase transmit power, it can maintain the radio link by appropriately controlling the transmit power. Accordingly, the radio base station 10 can appropriately control the transmit power of each of the radio terminals 20 and, simultaneously, stably maintain the radio link between each of the radio terminals 20 and the radio base station 10. In addition, the radio base station 10 can know the path loss of all of the radio resource blocks at every predetermined timing. Thereby, the radio base station 10 can control a downlink modulation scheme, beamforming of an antenna and the like, following changes of the radio state over time.

### Second Embodiment

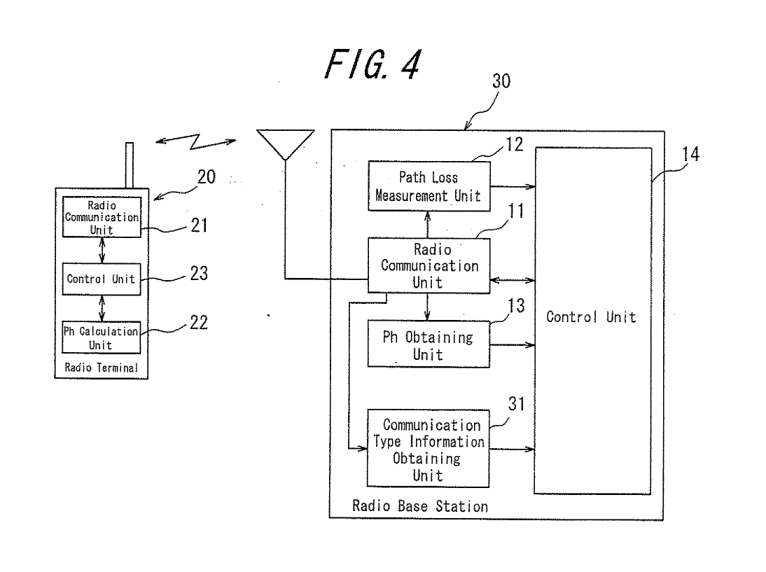

FIG. 4 is a schematic diagram illustrating a radio communication system having a radio base station according to a second embodiment of the present invention. A radio base station 30 according to the present embodiment further includes a communication type information obtaining unit 31 in addition to the configuration of the radio base station 10 shown in FIG. 1. The communication type information obtaining unit 31 obtains communication type information by recognizing a type of communication with each of the radio terminals 20 and provides the control unit 14 with the communication type information. According to the present embodiment, the communication type information obtaining unit 31 classifies the communication type information into a communication type (T1) requiring real-time property for a voice communication, streaming and the like, and a communication type (T2) for other data communications such as browsing and the like, and provides the control unit 14 with a result of classification.

At every predetermined timing, the control unit 14 controls (schedules) allocation of the radio resource blocks to the plurality of radio terminals 20 based on the path loss measured by the path loss measurement unit 12, the difference information Ph obtained by the Ph obtaining unit 13 and the communication type information obtained by the communication type information obtaining unit 31. Then, the control unit 14 transmits a result of control to a corresponding radio terminal 20 via the radio communication unit 11. Other configurations and operations are the same as those in FIG. 1.

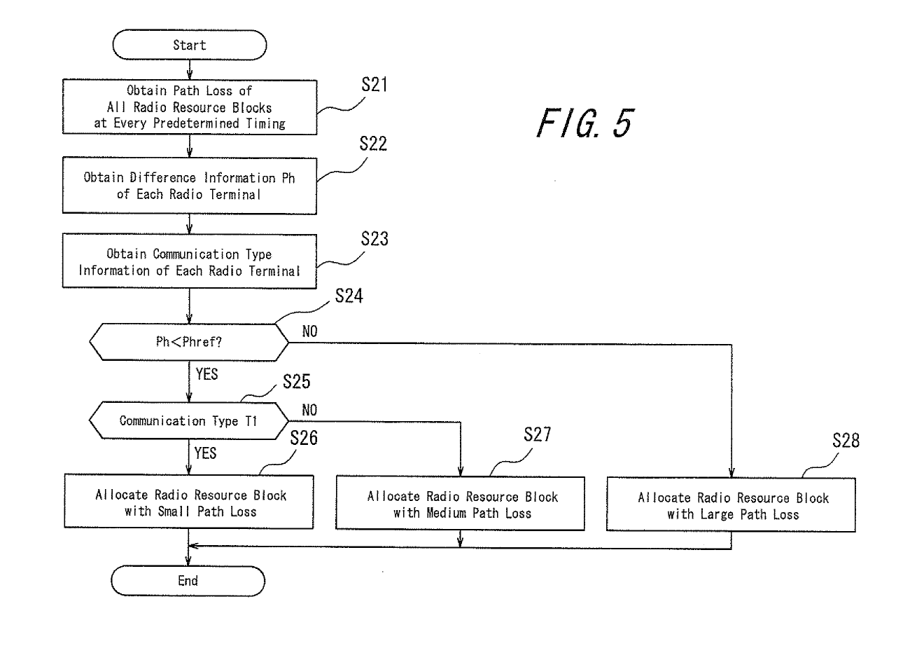

FIG. 5 is a flowchart illustrating a scheduling operation to allocate the radio resource blocks by the radio base station 30 according to the present embodiment. The control unit 14, in the same manner as that in the first embodiment, obtains the path loss of all of the radio resource blocks from the path loss measurement unit 12 at every predetermined timing (step S21). In addition, the control unit 14 obtains the difference information Ph of each of the radio terminals 20 from the Ph obtaining unit 13 (step S22). According to the present embodiment, moreover, the control unit 14, at every predetermined timing, obtains the communication type information of each of the radio terminals 20 being classified from the communication type information obtaining unit 31 (step S23).

Then, the control unit 14 compares, with respect to each of the radio terminals 20, the difference information Ph of the radio terminal 20 and the predetermined threshold Phref (step S24). If Ph<Phref as a result, since the radio terminal 20 has no room to increase transmit power, the control unit 14 further determines whether the communication type of the radio terminal 20 is the communication type T1 requiring the real-time property (step S25).

If it is the communication type T1 as a result, the control unit 14 schedules allocation of the radio resource blocks such that a radio resource block with the small path loss is preferentially allocated to the radio terminal 20 (step S26) and transmits a result of scheduling to the corresponding radio terminal 20.

If the communication type is T2, since it does not require the real-time property, the control unit 14 schedules allocation of the radio resource blocks such that a resource block with a medium path loss is preferentially allocated to the radio terminal 20 (step S27) and transmits a result of scheduling to the corresponding radio terminal 20.

In contrast, if Ph≧Phref at step S24, the radio terminal 20 has room to increase its transmit power. In this case, therefore, the control unit 14, in the same manner as that of the first embodiment, schedules allocation of the radio resource blocks such that a radio resource block with the large path loss is preferentially allocated to the radio terminal 20 (step S28) and transmits a result of scheduling to the corresponding radio terminal 20.

As stated above, in accordance with the radio state of each radio resource block which changes from moment to moment, the control unit 14 schedules the radio resource blocks allocated to the radio terminals 20 based on the radio state of each radio resource block, the difference information Ph of each radio terminal and the communication type.

According to the radio communication system having the radio base station 30 of the present embodiment, the radio resource block with the small path loss, that is, being in a good radio state is preferentially allocated to the radio terminal 20 having the difference information Ph under the threshold Phref and performing communication of the communication type T1 requiring the real-time property. Thereby, it is possible to maintain the radio link of the communication type T1 requiring the real-time property in a more stable manner, as well as to obtain the same effect as the first embodiment. It is thus possible to ensure QoS (Quality of Service) of the communication type T1.

It is also possible to determine whether the communication type is T1 if Ph≧Phref at step S24 in FIG. 5, and to allocate a radio block with the small path loss preferentially if the communication type is T1, and allocate a radio resource block with the large path loss preferentially if the communication type is T2.

### Third Embodiment

A radio base station according to a third embodiment of the present invention has a configuration shown in FIG. 4 and schedules allocation of radio resource blocks such that a radio resource block with the small path loss is preferentially allocated to a radio terminal 20 of the communication type T1 requiring the real-time property.

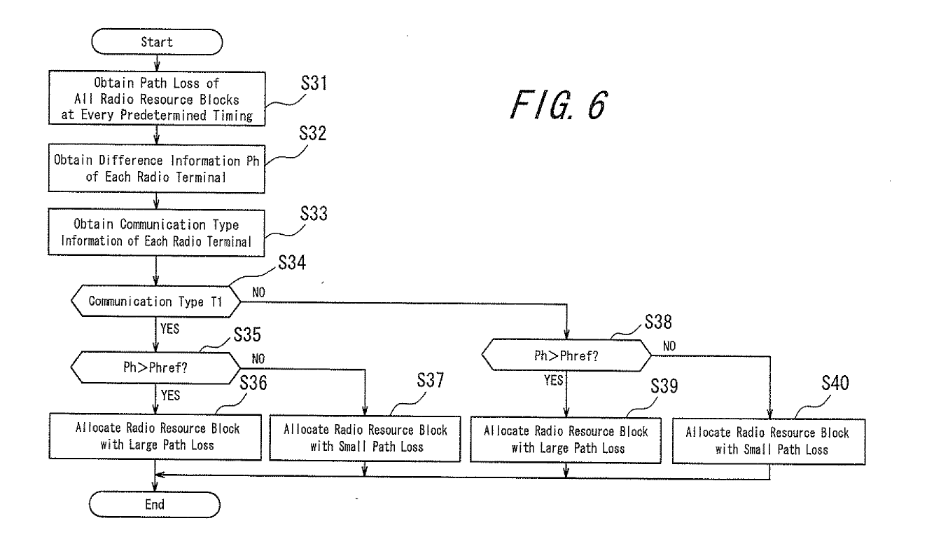

FIG. 6 is a flowchart illustrating a scheduling operation to allocate the radio resource blocks by the radio base station according to the present embodiment. The following is a description of the operation with reference to FIG. 4. The control unit 14, in the same manner as that of the second embodiment, obtains the path loss of all of the radio resource blocks from the path loss measurement unit 12 at every predetermined timing (step S31), the difference information Ph of each of the radio terminals 20 from the Ph obtaining unit 13 (step S32), and the communication type information of each of the radio terminals 20 being classified by the communication type information obtaining unit 31 (step S33).

Then, the control unit 14, in an opposite manner to the second embodiment, first determines whether the communication type of the radio terminal 20 is the communication type T1 requiring the real-time property (step S34). If it is the communication type T1 as a result, the control unit 14 compares the difference information Ph of the radio terminal 20 and a predetermined threshold Phref (step S35). If Ph>Phref as a result, since the radio terminal 20 has room to increase its transmit power, the control unit 14 schedules allocation of the radio resource blocks such that a radio resource block with the large path loss is preferentially allocated to the radio terminal 20 (step S36) and transmits a result of scheduling to a corresponding radio terminal 20.

In contrast, if Ph≦Phref is satisfied, since the radio terminal 20 has no room to increase its transmit power, the control unit 14 schedules allocation of the radio resource blocks such that a radio resource block with the small path loss is preferentially allocated to the radio terminal 20 (step S37) and transmits a result of scheduling to the corresponding radio terminal 20.

If it is the communication type T2 requiring no real-time property at step S34, the control unit 14 compares the difference information Ph and a threshold Phref (step S38) in the same manner as the first embodiment. If Ph>Phref as a result, the control unit 14 schedules allocation of the radio resource blocks such that a radio resource block with the large path loss is preferentially allocated to the radio terminal 20 (step S39) and transmits a result of scheduling to the corresponding radio terminal 20. In contrast, if Ph≦Phref is satisfied, the control unit 14 schedules allocation of the radio resource blocks such that a radio resource block with the small path loss is preferentially allocated to the radio terminal 20 (step S40) and transmits a result of scheduling to the corresponding radio terminal 20.

As stated above, the control unit 14 schedules the radio resource blocks allocated to the radio terminals 20 at every predetermined timing based on the radio state of each radio resource block, which changes from moment to moment, and the communication type and the difference information Ph of each radio terminal.

According to the radio communication system having the radio base station 30 of the present embodiment, the radio resource block with the small path loss, that is, being in the good radio state is preferentially allocated to the radio terminal 20 performing communication of the communication type T1 requiring the real-time property, based on the difference information Ph. Thereby, it is possible to ensure QoS of each communication type as well as to obtain the same effect as the second embodiment.

It is to be understood that the present invention is not limited to the above embodiments but may be modified or varied in a multiple of manners. For example, the present invention is widely applicable not only to LTE but also radio communication systems, such as WiMAX (Worldwide Interoperability for Microwave Access), UMB (Ultra Mobile Broadband), next generation PHS (Personal Handy-phone System), IMT-Advanced and the like, for performing radio communications by allocating a different radio resource to each of a plurality of radio terminals.

### REFERENCE SIGNS LIST

10 radio base station
11 radio communication unit
12 path loss measurement unit
13 Ph obtaining unit
14 control unit
20 radio terminal
21 radio communication unit
22 Ph calculation unit
23 control unit
30 radio base station
31 communication type information obtaining unit

1. A radio base station for performing radio communication with a plurality of radio terminals by allocating a different radio resource to each of the plurality of radio terminals, comprising:
a measurement unit for measuring a path loss on the radio resource allocated to each of the plurality of radio terminals at every predetermined timing;
a difference information obtaining unit for obtaining difference information between maximum transmit power and current transmit power, transmitted from each of the plurality of radio terminals; and
a control unit for controlling allocation of the radio resources to the plurality of radio terminals based on the path loss measured by the measurement unit and the difference information obtained by the difference information obtaining unit.

2. The radio base station according to claim 1, wherein the control unit allocates the radio resource with relatively small path loss measured by the measurement unit to the radio terminal with relatively small difference information obtained by the difference information obtaining unit, while allocating the radio resource with relatively large path loss measured by the measurement unit to the radio terminal with relatively large difference information obtained by the difference information obtaining unit.

3. The radio base station according to claim 1, further comprising:
a communication type information obtaining unit for obtaining communication type information indicating a communication type of each of the plurality of radio terminals, wherein
the control unit controls allocation of the radio resources to the plurality of radio terminals, based on the path loss measured by the measurement unit, the difference information obtained by the difference information obtaining unit and the communication type information obtained by the communication type information obtaining unit.

4. A radio resource allocation method of a radio base station for performing radio communication with a plurality of radio terminals by allocating a different radio resource to each of the plurality of radio terminals, comprising the steps of
measuring a path loss on the radio resource allocated to each of the plurality of radio terminals at every predetermined timing;
obtaining difference information between maximum transmit power and current transmit power, transmitted from each of the plurality of radio terminals; and
controlling allocation of the radio resources to the plurality of radio terminals based on the path loss measured and the difference information obtained.

5. A radio communication system comprising a radio base station for performing radio communication with a plurality of radio terminals by allocating a different radio resource to each of the plurality of radio terminals, wherein
each of the plurality of radio terminals comprises:
a calculation unit for outputting difference information by calculating a difference between current transmit power and maximum transmit power that the radio terminal can transmit; and
a transmission unit for transmitting the difference information output from the calculation unit to the radio base station, and
the radio base station comprises:
a measurement unit for measuring a path loss on the radio resource allocated to each of the plurality of radio terminals at every predetermined timing;
a difference information obtaining unit for obtaining the difference information transmitted from each of the plurality of radio terminals; and
a control unit for controlling allocation of the radio resources to the plurality of radio terminals based on the path loss measured by the measurement unit and the difference information obtained by the difference information obtaining unit.

6. The radio base station according to claim 2, further comprising:
a communication type information obtaining unit for obtaining communication type information indicating a communication type of each of the plurality of radio terminals, wherein
the control unit controls allocation of the radio resources to the plurality of radio terminals, based on the path loss measured by the measurement unit, the difference information obtained by the difference information obtaining unit and the communication type information obtained by the communication type information obtaining unit.
